(19) United States
(12) Patent Application Publication
(10) Pub. No.: US 2024/0414811 A1
(43) Pub. Date: Dec. 12, 2024

(54) METHOD FOR MANAGING AN EMERGENCY SITUATION AND TERMINAL IMPLEMENTING THIS METHOD

(71) Applicant: ORANGE, ISSY LES MOULINEAUX (FR)

(72) Inventors: Mickael Allain, Chatillon Cedex (FR); Eddy Goffin, Chatillon Cedex (FR)

(21) Appl. No.: 18/698,094

(22) PCT Filed: Oct. 3, 2022
(86) PCT No.: PCT/EP2022/077481

§ 371 Date: Apr. 3, 2024

(30) Foreign Application Priority Data
Oct. 4, 2021 (FR) FR2110476

(51) Int. Cl. H04W 76/50; H04L 65/1016; H04L 65/1045; H04W 4/90; H04W 40/20

(52) U.S. Cl. CPC H04W 76/50; H04L 65/1016; H04L 65/1045; H04W 4/90; H04W 40/20

(57) ABSTRACT

A method for managing an emergency situation implemented by a terminal. The method includes: detecting an emergency situation; establishing an emergency channel with an emergency call management gateway, via an access point reserved for the emergency calls and whose identifier is recorded in the terminal; and sending an SMS-type emergency short message or an emergency data message, in said emergency channel, to an emergency service center.

### CROSS-REFERENCE TO RELATED APPLICATIONS

This Application is a Section 371 National Stage Application of International Application No. PCT/EP2022/077481, filed Oct. 3, 2022, and published as WO 2023/057396 A1 on Apr. 13, 2023, not in English, which claims priority to French Patent Application No. 2110476, filed Oct. 4, 2021, the contents of which are hereby incorporated by references in their entireties.

### FIELD OF THE INVENTION

The invention relates to the general field of the management of emergency calls made by a terminal in a telecommunications network.

It applies particularly, but in a non-limiting manner, when the terminal is in a roaming situation.

### BACKGROUND

FIG. 1 represents a terminal 10 of a user roaming in a visited network VN interconnected, via an IPX network, to a home network RN of the user.

It is assumed that the terminal 10 has established an IMS connectivity (by an ims apn for ims access point name) and a data connectivity (by a data apn access point) and that it establishes an emergency connectivity (via a sos apn access point) to make an emergency voice call to an emergency service center CSE.

This figure is placed in the context of an S8HR (S8 Home routed) network architecture and an LBO (Local Break Out) architecture known to those skilled in the art. In the S8HR architecture, the data connectivity (data apn) and the IMS connectivity (used in particular for the short message service SMS) are called “Home routed”, which means that they only pass through the visited network VN to be conveyed to and processed by the home network RN of the terminal.

The LBO architecture has the advantage of being able to manage part of the services in the visited network.

This is for example the case for the data connectivity (data apn).

This is also the case for a “SOS” emergency voice call made by the terminal on the emergency connectivity (sos apn). According to the LBO architecture, a “sos” emergency voice call made by a terminal in the visited network VN on the emergency connectivity (sos apn) is managed by the visited network and conveyed to the emergency service center CSE without going through the home network RN of the terminal.

But for the IMS services managed through an IMS connectivity (ims apn), the traffic is managed in the home network RN of the terminal.

The LBO roaming solution known to date therefore does not allow processing a short SMS message in a network visited by a user. If the user were to send a short SMS message as part of an emergency call, it would be redirected to the home network of the user. This is not possible, as an emergency message must be processed as close as possible to the user. In this solution, a data message, as part of an emergency call, would be processed through data connectivity in the visited network as any data, without emergency criteria.

Moreover, it can be noted that the LBO services are very little deployed. Indeed, the roaming architecture which is becoming widespread worldwide is the one known to those skilled in the art under the name S8HR, in which all traffic (voice, short SMS messages, data) is redirected to the home network.

The S8HR roaming solution known to date therefore does not allow processing a short SMS message or a data message in a network visited by a user. If the user were to send a short SMS message or a data message as part of an emergency call, it would also be redirected to the home network of the user.

The invention proposes a mechanism for managing the emergency calls, which does not present the drawbacks of the prior art.

### SUMMARY OF THE INVENTION

According to a first aspect, the invention relates to a method for managing an emergency situation, implemented by a terminal. This method includes:
a step of detecting an emergency situation;
a step of establishing an emergency channel with an emergency call management gateway, via an access point reserved for the emergency calls and whose identifier is recorded in the terminal;
a step of sending an SMS-type emergency short message or an emergency data message, in said emergency channel, to an emergency service center.

Correlatively, the invention relates to a terminal including:
a module for detecting an emergency situation;
a communication module configured to establish an emergency channel with an emergency call management gateway, via an access point reserved for the emergency calls and whose identifier is recorded in the terminal; and
a communication module configured to send an SMS-type emergency short message or an emergency data message, in said emergency channel, to an emergency service center.

Within the framework of the invention, an emergency situation is any type of situation in which an emergency call can be made. It can be triggered voluntarily by the user, for example by pressing a button or dialing an emergency number. It can also be detected according to predetermined conditions, for example in the event of an accident, for example by an accelerometer.

The terminal is configured to be able to make emergency calls by connecting to an emergency access point whose identifier is recorded in the terminal.

In accordance with the invention, when such a situation is detected, the terminal establishes an emergency channel with an emergency call management gateway, via this access point.

This emergency channel can be used to carry a voice call.

In accordance with the invention, the emergency channel is used by the terminal to send an SMS-type emergency short message or an emergency data message.

When a voice call is made in the emergency channel, the emergency short message or the emergency data can include context data of this voice call, for example the geographical position of the terminal.

As a variant, the emergency short message or the emergency data may not accompany a voice call. This is in particular the case when the user of the terminal is hard of hearing.

According to a second aspect, the invention relates to a method for processing an emergency call implemented by an emergency call management gateway, this method including:
a step of establishing an emergency channel with a terminal via an access point reserved for the emergency calls;
a step of receiving an SMS-type emergency short message in said emergency channel; and
a step of routing said emergency short message to an emergency service center via an IMS network.

Correlatively, the invention relates to an emergency call management gateway, this gateway including:
a communication module configured to establish an emergency channel with a terminal via an access point reserved for the emergency calls;
said communication module being configured to receive an SMS-type emergency short message in said emergency channel and to route said emergency short message to an emergency service center via an IMS network.

The gateway in accordance with the invention is therefore configured to be able to receive, in an emergency channel, an emergency short message and to route this short message via an IMS network.

In one embodiment, the emergency call management gateway is further configured to be able to receive emergency data in the emergency channel and to route these emergency data to an emergency service center, via an Internet network for example.

The invention is particularly advantageous when the terminal is in roaming situation, the access point and the gateway being located in a visited network by the terminal.

Indeed, the emergency short message or the emergency data can be routed to the emergency service center via the visited network itself without intervention of the home network of the terminal.

In one particular embodiment of the method for managing an emergency situation, the terminal obtains an address of a P-CSCF entity of an IMS network, said emergency short message being sent to said address, via said emergency channel.

In this embodiment, the emergency call management gateway routes the SMS-type emergency short message via this P-CSCF entity.

In one particular embodiment, the short message is then conveyed:
by an E-CSCF (Emergency-CSCF) platform; then
by an IP-SM-GW (IP Short Message Gateway) short message gateway; then
by an SMSC (Short Message Service Center) messaging center to the CSE emergency service center (ambulance, police, firemen, . . . ).

In one particular embodiment, the emergency short message is routed to its recipient based on the telephone number (MSISDN) of the latter. The destination of the emergency number can for example be identified by the short number of the targeted emergency service (e.g. 112) or by the URN of the service as specified in RFC 5031.

The conversion of the destination from a URN format into a telephone number, when necessary, can be carried out either by the CSCF entity of the IMS, the IP-SM-GW or the SMSC, depending on the mode of implementation chosen by the operator of the visited network VN.

In one particular embodiment of the method for managing an emergency situation, the terminal is configured to obtain a standardized URL corresponding to the emergency service center (CSE), and to address an emergency data message to this standardized URL via the emergency channel.

In one particular embodiment, the different steps of the method for managing an emergency situation are determined by computer program instructions or are implemented by a silicon chip which comprises transistors adapted to constitute logic gates of a non-programmable hardwired logic.

Consequently, the invention also relates to a computer program on an information medium, this program being likely to be implemented in a device or more generally in a computer, this program including instructions adapted to the implementation of the steps of an emergency management method as described above.

This program can use any programming language, and be in the form of source code, object code or intermediate code between source code and object code, such as in a partially compiled form or in any other desirable form.

The invention also relates to an information medium readable by a computer, and including instructions of a computer program as mentioned above. The information medium can be any entity or device capable of storing the program. For example, the medium can include a storage means, such as a ROM, a non-volatile memory of the flash type or a magnetic recording means, for example a hard disk. On the other hand, the information medium can be a transmissible medium such as an electrical or optical signal, which can be conveyed via an electrical or optical cable, by radio or by other means. The program according to the invention can be particularly downloaded from an Internet type network. Alternatively, the information medium can be an integrated circuit in which the program is incorporated, the circuit being adapted to execute or to be used in executing the method in question.

### BRIEF DESCRIPTION OF THE DRAWINGS

Other characteristics and advantages of the present invention will emerge from the description given below, with reference to the appended drawings which illustrate exemplary embodiments devoid of any limitation. In the figures:

FIG. 1, already described, represents an emergency call management solution of the prior art;

FIG. 2 represents a terminal in accordance with one particular mode of implementation of the invention;

FIG. 3 represents the hardware architecture of a terminal in accordance with one particular mode of implementation of the invention;

FIG. 4 represents, in flowchart form, the main steps of a method for managing the emergency calls in accordance with one particular embodiment of the invention;

FIG. 5 represents one example of implementation of the invention by a terminal located in its home network;

FIG. 6 represents one example of implementation of the invention by a terminal located in a visited network; and

FIG. 7 represents the hardware architecture of a gateway in accordance with one particular mode of implementation of the invention.

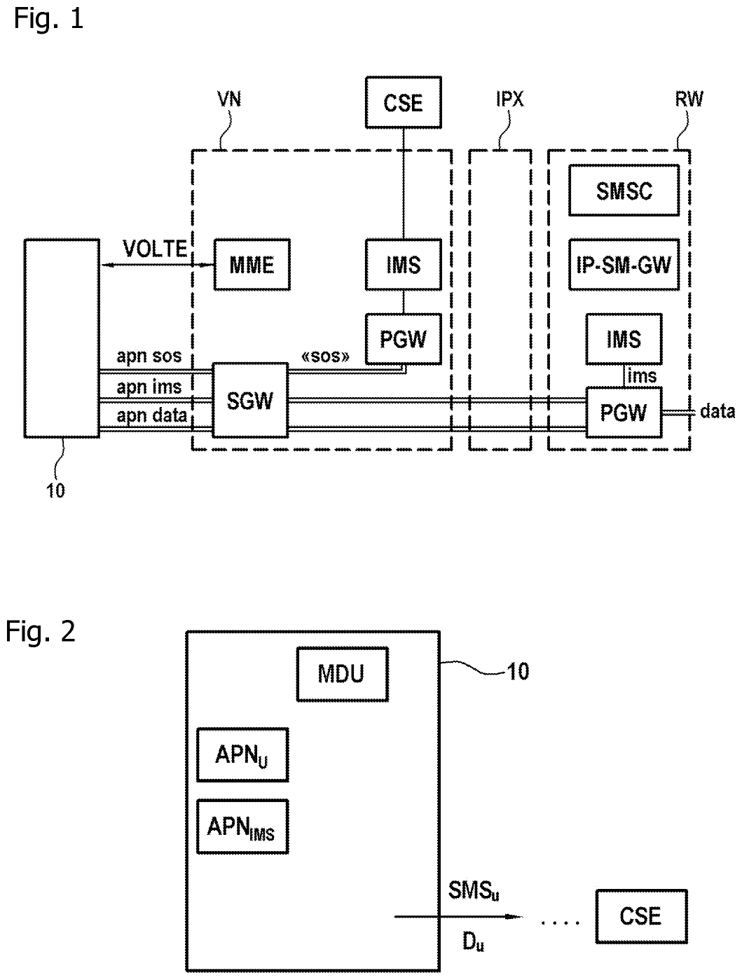

### DESCRIPTION OF THE EMBODIMENTS

FIG. 2 represents a terminal 10 in accordance with one particular embodiment of the invention.

In the embodiment described here, the terminal 10 is compatible with VOLTE/VoNR (Voice over Long Term Evolution/Voice over New Radio) technology and configured to be able to make, on a 4G LTE or 5G network, voice calls in voice over IP (VOIP) and short messages of the type SMS over IP (SMSoIP).

Those skilled in the art can refer to document IR.92 of the GSMA “IMS Profile for Voice and SMS”, version 16.0, of 28 May 2021 or NG.114 “IMS Profile for Voice, Video and Messaging over 5GS” which define the characteristics to be supported by the terminals (UE user equipment) and the network to offer a telephone and short SMS message service in the standardized IMS (IP multimedia subsystem) architecture.

In the embodiment described here, the terminal 10 includes an MDU module to detect an emergency situation (for example when the user presses a button on the terminal 10) and, where appropriate, to trigger the sending of an emergency short message SMSu, or the sending of an emergency data message Dᵤ to an emergency service center CSE.

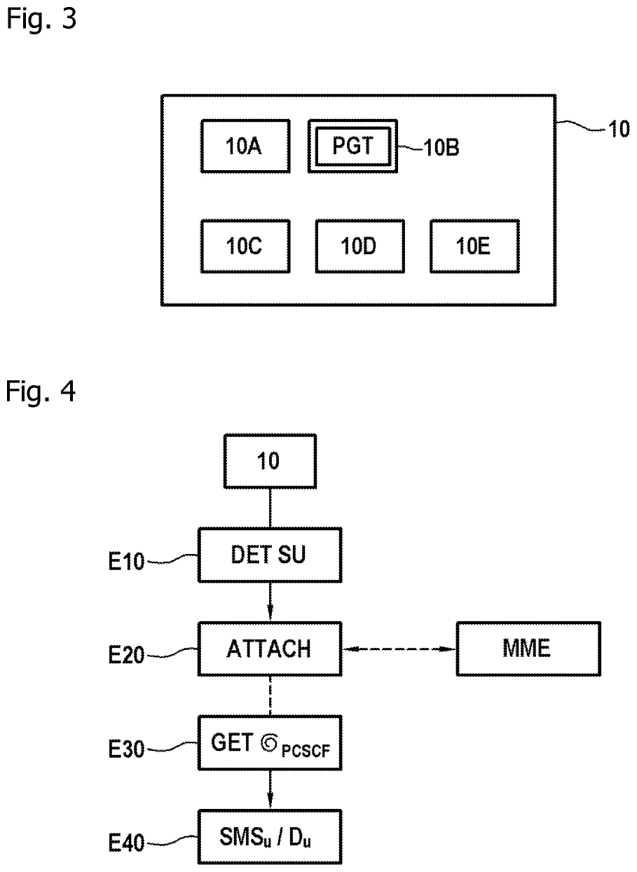

FIG. 3 represents the hardware architecture of the terminal 10. In the embodiment described here, the terminal 10 has hardware architecture of a computer. It in particular comprises a processor 10A, a read-only memory 10B, a random access memory 10C, a rewritable non-volatile memory 10D and communication means 10E.

The read-only memory 10B of the device 10 constitutes a recording medium in accordance with the invention, readable by the processor 10A and on which a PGT computer program in accordance with the invention is recorded, this program including instructions for the execution of the steps of a method for managing an emergency situation according to the invention, the main steps of which are described with reference to FIG. 4 in one embodiment.

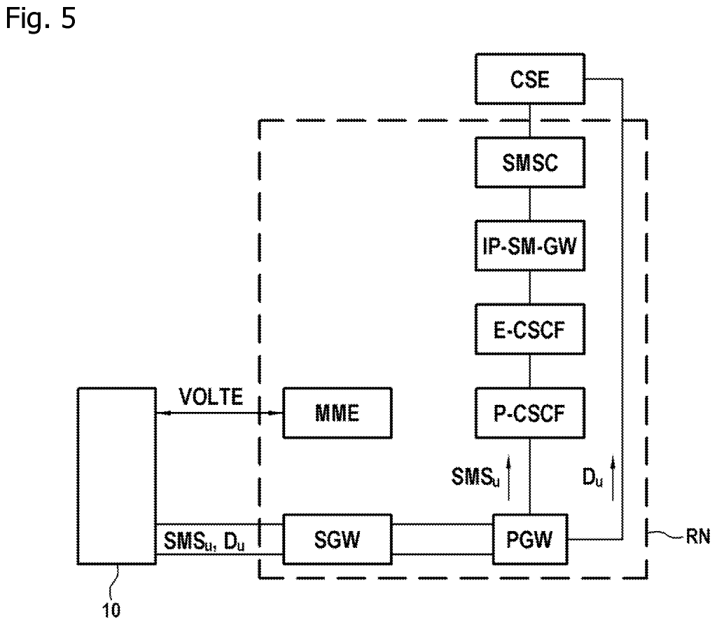

FIG. 5 represents one embodiment of the invention in which the terminal 10 is located in its home network RN and is configured to send an emergency short message SMSu or an emergency data message Dᵤ to the emergency service center CSE, possibly accompanied by an emergency voice call.

During a step E10, the terminal 10 detects an emergency situation SU and determines that it must activate an emergency service associated with an emergency number.

In the embodiment described here, the emergency numbers known to the terminal 10 are for example 112 (European emergency call), 15 (ambulance in France), 17 (police in France) and 18 (firemen in France).

The document of reference IETF RFC 5031 proposes a name space for the Uniform Resource Names (URNs) associated with these emergency services.

For example:
for the European emergency number 112, urn=urn: service: sos;
for the French emergency number 15, urn=urn: service: sos.ambulance
for the French emergency number 17, urn=urn: service: sos.police.
for the French emergency number 18, urn=urn: service: sos.fire.

During a step E20, the terminal 10 makes a request for attachment to a mobility management entity (MME), and the MME entity selects, based on an access point APNu reserved for emergency calls, a PGW gateway (Packet Data Network Gateway) in accordance with the invention and configured to manage emergency calls as part of this service. In the embodiment described here, the terminal 10 also includes an IMS access point name APNIs for sending SMS other than the emergency SMS.

The MME entity creates a bearer between the terminal 10 and a SGW gateway (serving gateway) and between this SGW gateway and the PGW gateway configured to manage emergency calls.

An emergency channel CU is thus established between the terminal 10 and a PGW gateway for managing emergency calls.

This step E20 of establishing an emergency channel CU is known per se, but in the current state of the art, this emergency channel CU is used exclusively to carry voice emergency calls. As mentioned previously, the invention proposes to use this emergency channel CU to allow the sending, by the terminal 10, of an emergency short message SMSu or of an emergency data message Dᵤ.

The PGW gateway validates the emergency session request by sending to the terminal 10, the IP address @P-CSCF of a P-CSCF (Proxy Call Session Control Function) entity of the home network.

The terminal 10 determines that it must, as part of the emergency session, send all its IMS traffic, and particularly the short messages SMSoIP to this IP address.

It will be first assumed that during a step E40, the terminal 10 sends an emergency short message SMSu, to this IP address @P-CSCF, via the emergency channel CU. This short message SMSu includes for example the location of the terminal 10.

The home network RN of the operator includes an E-CSCF (Emergency-CSCF) platform configured to convey emergency session requests received from the P-CSCF to the emergency service center CSE. The operator can also choose to process emergency sessions through an S-CSCF).

In the embodiment described here, the emergency SMS is sent by the E-CSCF entity to a short message gateway IP-SM-GW.

The Short Message Gateway IP-SM-GW is an IMS application server that manages the SIP-based messaging services for the IMS subscribers. This IP-SM-GW gateway is configured to interact with an SMSC messaging center (Short Message Service Center) to transmit the short message to its recipient, typically an emergency service center CSE (ambulance, police, firemen, . . . ).

It is now assumed that the terminal 10 sends, during step E40, emergency data Dᵤ to the emergency service center CSE.

In this embodiment, the terminal 10 sends these emergency data Dᵤ, in the emergency channel CU, to a standardized URL URLcsE known to the terminal. A Domain Name Server (DNS) resolves this URL and provides a target IP address associated with the emergency service center CSE.

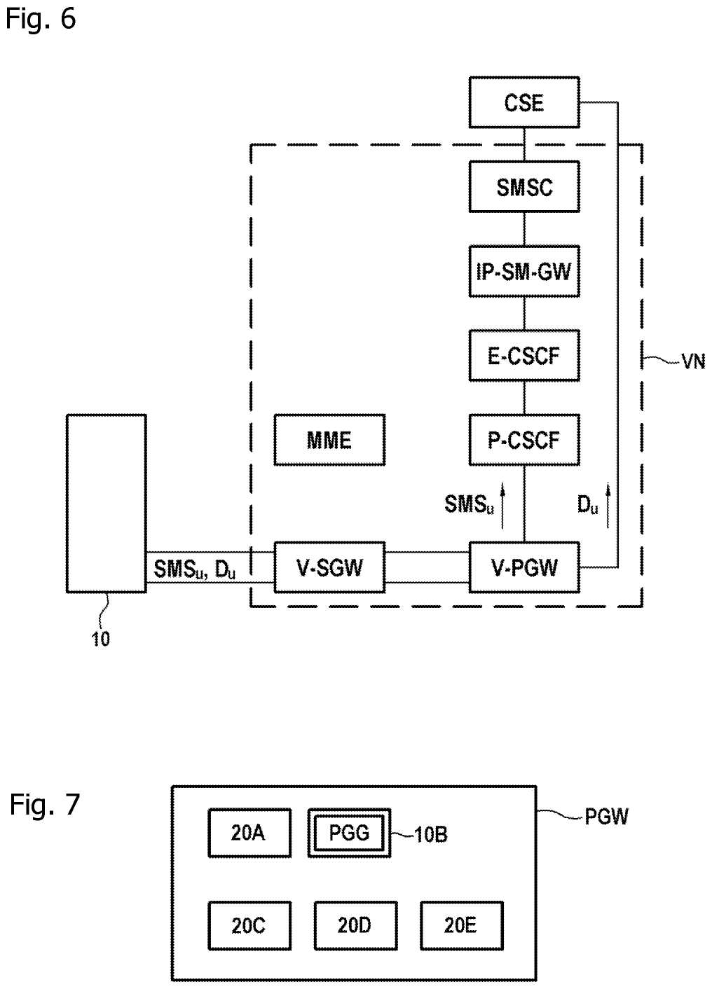

In the example of FIG. 5, it was assumed that the terminal 10 was located in its home network 10. FIG. 6 represents the situation in which the terminal 10 is in a roaming situation, in a visited network VN. In this scenario, during step E20, when the terminal 10 makes its attachment request to a mobility management entity MME of the visited network, the latter selects a PGW gateway of the visited network and establishes an emergency channel between the terminal 10 and this PGW gateway in the visited network.

The emergency short messages SMSu and the emergency data Dᵤ are thus conveyed either directly (for the emergency data Dᵤ) or via a visited IMS network (for the emergency short messages SMSu) to the emergency service center CSE.

FIG. 7 represents the hardware architecture of a PGW or V-PGW gateway in accordance with the invention and as represented in FIGS. 5 and 6 already described. In the embodiment described here, the PGW or V-PGW gateway has a hardware architecture of a computer. It in particular comprises a processor 20A, a read-only memory 20B, a random access memory 20C, a rewritable non-volatile memory 20D and communication means 20E.

The read-only memory 20B of the gateway constitutes a recording medium in accordance with the invention, readable by the processor 20A and on which a computer program PGG in accordance with the invention is recorded, this program including instructions for the execution of the steps of a method for processing an emergency call according to the invention and whose main steps comprise:
the establishment (E20) of an emergency channel (CU) with a terminal (10) via an access point reserved for the emergency calls (APn) and whose identifier is recorded in the terminal (10);
the receipt (E40) of an SMS-type emergency short message (SMSu) in said emergency channel (CU); and
the routing of the emergency short message (SMSu) to an emergency service center (CSE) via an IMS network.

Although the present disclosure has been described with reference to one or more examples, workers skilled in the art will recognize that changes may be made in form and detail without departing from the scope of the disclosure and/or the appended claims.

1. A method for managing an emergency situation, implemented by a terminal, the method including:
detecting an emergency situation;
establishing an emergency channel with an emergency call management gateway, via an access point reserved for emergency calls and having an identifier is recorded in the terminal; and
of sending a short message service (SMS)-type emergency short message or an emergency data message, in said emergency channel, to an emergency service center.

2. The method for managing an emergency situation according to claim 1, including obtaining an address of a proxy call session control function (P-CSCF) entity of an Internet Protocol Multimedia Subsystem (IMS) network, said emergency short message being sent to said address, via said emergency channel.

3. The method for managing an emergency situation according to claim 1, including obtaining a standardized uniform resource locator (URL) corresponding to said emergency service center, said emergency data message being addressed to said standardized URL via said emergency channel.

4. The method for managing an emergency situation according to claim 1, wherein said terminal is in a roaming situation and said access point and said gateway are located in a visited network by said terminal.

5. A method for processing an emergency call implemented by an emergency call management gateway, the method comprising:
establishing an emergency channel with a terminal via an access point reserved for emergency calls;
receiving a short message service (SMS)-type emergency short message in said emergency channel; and
routing said emergency short message to an emergency service center via an IMS network.

6. A terminal comprising:
at least one processor;
at least one non-transitory computer readable medium comprising instructions stored thereon which when executed by the at least one processor configure the terminal to:
detect an emergency situation;
establish an emergency channel with an emergency call management gateway, via an access point reserved for emergency calls and having identifier is recorded in the terminal; and
send a short message service (SMS)-type emergency short message or an emergency data message, in said emergency channel, to an emergency service center.

7. An emergency call management gateway comprising:
at least one processor;
at least one non-transitory computer readable medium comprising instructions stored thereon which when executed by the at least one processor configure the emergency call management gateway to:
establish an emergency channel with a terminal via an access point reserved for emergency calls; and
receive a short message service (SMS)-type emergency short message in said emergency channel; and
route said emergency short message to an emergency service center via an IMS network.

8. The emergency call management gateway according to claim 7, the gateway being configured to be able to receive emergency data in said emergency channel and to route said emergency data to the emergency service center.

9. A non-transitory computer readable medium having stored thereon instructions which, when executed by a processor, cause the processor to implement the method of claim 1.

10. A non-transitory computer readable medium having stored thereon instructions which, when executed by a processor, cause the processor to implement the method of claim 5.
